(19) United States
(12) Patent Application Publication
(10) Pub. No.: US 2019/0114680 A1
(43) Pub. Date: Apr. 18, 2019

(54) Customized Placement of Digital Marketing Content in a Digital Video

(71) Applicant: Adobe Systems Incorporated, San Jose, CA (US)

(72) Inventors: Jen-Chan Jeff Chien, Saratoga, CA (US); Thomas William Randall Jacobs, Cupertino, CA (US); Kent Andrew Edmonds, San Jose, CA (US); Kevin Gary Smith, Lehi, UT (US); Peter Raymond Fransen, Soquel, CA (US); Gavin Stuart Peter Miller, Los Altos, CA (US); Ashley Manning Still, Atherton, CA (US)

(73) Assignee: Adobe Systems Incorporated, San Jose, CA (US)

(21) Appl. No.: 15/783,228

(22) Filed: Oct. 13, 2017

(51) Int. Cl. G06Q 30/02; G06N 99/00

(52) U.S. Cl. CPC G06Q 30/0277; G06N 99/005

(57) ABSTRACT

Techniques and system are described to control output of digital marketing content with respect to a digital video that address the added complexities of digital video over other types of digital content, such as webpages. In one example, the techniques and systems are configured to control a time, at which, digital marketing content is to be output with respect to the digital video, e.g., by selecting a commercial break or output as a banner ad in conjunction with the video.

### BACKGROUND

Digital video has an increased ability to capture and hold a user's attention over other types of digital content. A digital video, for instance, that is of interest to a user is likely to hold a user's attention over a majority of a length in output of the video, e.g., for a funny digital video sent from a friend. On the other hand, a static digital image on a webpage may be quickly glanced at and consumed by a user, even in instances in which the user is interested in the digital image.

Conventional digital marketing systems, however, typically address digital video in a manner that is similar to how other types of digital content are consumed by a user, e.g., webpages. Accordingly, these conventional digital marketing systems fail to address the increased richness of digital video and corresponding ability to capture and hold a user's attention. As a result, conventional digital marketing systems have increased inefficiencies and missed opportunities in the selection and output of digital marketing content in conjunction with digital video due to an inability to address these differences.

### SUMMARY

Techniques and system are described to control output of digital marketing content with respect to a digital video that address the added complexities of digital video over other types of digital content, such as webpages. In one example, the techniques and systems are configured to control a time, at which, digital marketing content is to be output with respect to the digital video, e.g., by selecting a commercial break or output as a banner ad in conjunction with the video. Thus, these techniques and systems address a timing consideration of digital video that is not applicable in other forms of digital content, e.g., webpages.

In another example, tags are included as part of the digital video that describe characteristics of respective portions of the digital video, e.g., emotional states or other characteristics of content exhibited within frames of the video. These tags may be used by a creative professional to guide output of digital marketing content to promote a consistent look and feel. The tags may also be leveraged by a digital marketing system to gain insight into the video that may be used to increase accuracy and efficiency in selection of digital marketing content, e.g., using machine learning, tag matching, rules based, and so on. A variety of other examples are also contemplated as further discussed in the Detailed Description.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ digital video techniques described herein.

FIG. 2 depicts an example implementation showing operation of a tag creation module of a content creation system of FIG. 1 in greater detail.

FIG. 3 depicts an example system in which a tag is used as a basis to control output of digital marketing content in conjunction with digital video.

FIG. 4 depicts an example implementation showing operation of a digital marketing system of FIG. 1 in greater detail as employing machine learning to generate a suggestion.

FIG. 5 depicts a system in an example implementation in which a suggestion is generated based on machine learning usable to control output of digital marketing content with respect to digital video.

FIG. 6 depicts a system in an example implementation in which a suggestion is generated to guide content creation through user interaction with a content creation system.

FIG. 7 is a flow diagram depicting a procedure in an example implementation of control of digital marketing content with respect of a digital video.

FIG. 8 illustrates an example system including various components of an example device that can be implemented as any type of computing device as described and/or utilize with reference to FIGS. 1-7 to implement embodiments of the techniques described herein.

### DETAILED DESCRIPTION

Overview

The consumption of digital content continues to expand due to the increase in the number of ways users may capture, share, and receive digital content. A user, for instance, may interact with a mobile phone to capture a digital video and share that digital video via a content distribution system (e.g., YouTube®) for viewing by other users via respective client devices.

Oftentimes, the content distribution system may make opportunities available to output digital marketing content by providers of goods or services as part of distribution of the digital video. Conventional techniques to do so, however, are static and inflexible and thus cause conventional digital marketing systems to suffer from numerous inefficiencies. These inefficiencies lower a likelihood of conversion of a respective good or service, e.g., to “click” on an advertisement, purchase the good or service, and so forth.

Accordingly, techniques and system are described to control output of digital marketing content with respect to a digital video. A content creation system, for instance, may include functionality that is usable by a creative professional to define characteristics of a portion of the digital video that corresponds to this time, e.g., via a tag. In this way, the content creation system gives the creative professional a way in which to control what types of digital marketing content are to be output in conjunction with the digital video being created by the professional, even when distributed by a third party system, e.g., a content distribution system such as YouTube® or other streaming service system.

The content creation system, for instance, may receive user inputs to create the digital video from the creative professional. As part of this, the creative professional may also specify tags as part of the digital video (e.g., associated with particular timestamps, frames, and so on) describing characteristics of respective portions of the digital video. These tags may then be used by a content distribution system and/or a digital marketing system to control output of digital marketing content in conjunction with the digital video.

A tag, for instance, may indicate an emotional state of corresponding portion of the digital video as “somber.” This tag may be used by the content distribution system and/or digital marketing system to select digital marketing content for output in relation to this corresponding portion of the digital video. The digital marketing system, for instance, may select digital marketing content having a somber tone to be consistent with the somber tag, e.g., via tag matching. In another instance, the digital marketing system selects digital marketing content having a much different emotional state based on a set of rules, e.g., to select an advertisement having playful puppies that may be welcomed by users that watched the somber portion of the digital video. Other examples are also contemplated, including the use of machine learning. In this way, the digital marketing content that is output in conjunction with the digital video has an increased likelihood of being of interest to viewers of the digital video.

Techniques and systems are also described to generate suggestions regarding a time at which digital content is to be output in conjunction with a digital video, a tag to be associated with a corresponding portion of the digital video (e.g., in real time), and/or which digital marketing content is to be output with relation to a particular time and/or tag. A digital marketing system, for instance, may collect training data that describes user interaction with respective items of digital marketing content that are output in relation to digital videos and when that interaction occurred. From this, the digital marketing system trains a model using machine learning to generate suggestions that are usable to predict which items of digital marketing content are likely to be successful in causing performance of a desired action, e.g., conversion of a good or service.

This model may then be used to predict when to output the digital marketing content in conjunction with a subsequent digital video. The suggestions, for instance, may specify output of a banner advertisement as an overlay associated with a particular timestamp of the subsequent digital video, output as part of a “commercial break,” and so forth. In this way, the techniques and systems described herein may address the element of time as part of control of output of digital marketing content, which is not possible or even applicable in other forms of digital content.

In another instance, the training data describes tags associated with training digital videos that specify characteristics of respective portions of the digital videos, e.g., a particular emotional state, actors, lighting, genre, and so on. A model is then trained using this training data may to process a subsequent digital video to assign a tag to a subsequent digital video. In one example, this is performed in real time as the digital video is streamed, such as for a sporting event, awards show, and so forth to assign tags to respective portions of the digital video. In this way, the tags may provide insights even for “live” digital video, which is not possible using conventional systems.

Suggestions may also be used to guide creation of the digital video. A creative professional, for instance, may be guided by knowledge of tags that were successful in causing conversion to also include characteristics when creating a digital video. Thus, a subsequent digital video created based on this insight has a greater likelihood of resulting in conversion of a good or service in this example based on these characteristics which is not possible in conventional techniques.

The model may also be used to automatically generate tags for association with the subsequent digital video, e.g., associated with respective timestamps, frames, and so forth. As a result, the digital video may be tagged automatically and without user intervention to include tags usable to guide output of digital marketing content (e.g., which may also be tagged automatically and without user intervention) in an efficient and accurate manner using machine learning. Other examples are also contemplated, include hybrid examples in which the tags are automatically generated by the computing device and then confirmed by a user through interaction with a user interface. As a result, these techniques are applicable to a wider range of digital videos that do not already include tags.

In a further instance, the training data describes digital marketing content that is output with respect to particular tags associated with digital videos. A model generated from this training data using machine learning is then be used to generate suggestions regarding which items of digital marketing content are to be output with respective portions of a digital video. In the “somber” digital video example above, for instance, the model may learn that digital marketing content having a “happy” emotional state is more effective than digital marketing content having a “somber” emotional state when output in conjunction with the somber digital video. In this way, the model may learn and generate suggestions for correlations between tags of a digital video and corresponding digital marketing content that are not readily determined by a human, alone. Accordingly, the model may support increased efficiency and accuracy over conventional techniques and systems that are not capable of addressing these aspects of digital video as further described in the following sections. Other examples are also contemplated regarding selection of digital marketing content, including tag matching, rules employed by a rules engine, and so on as further described in the following sections.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

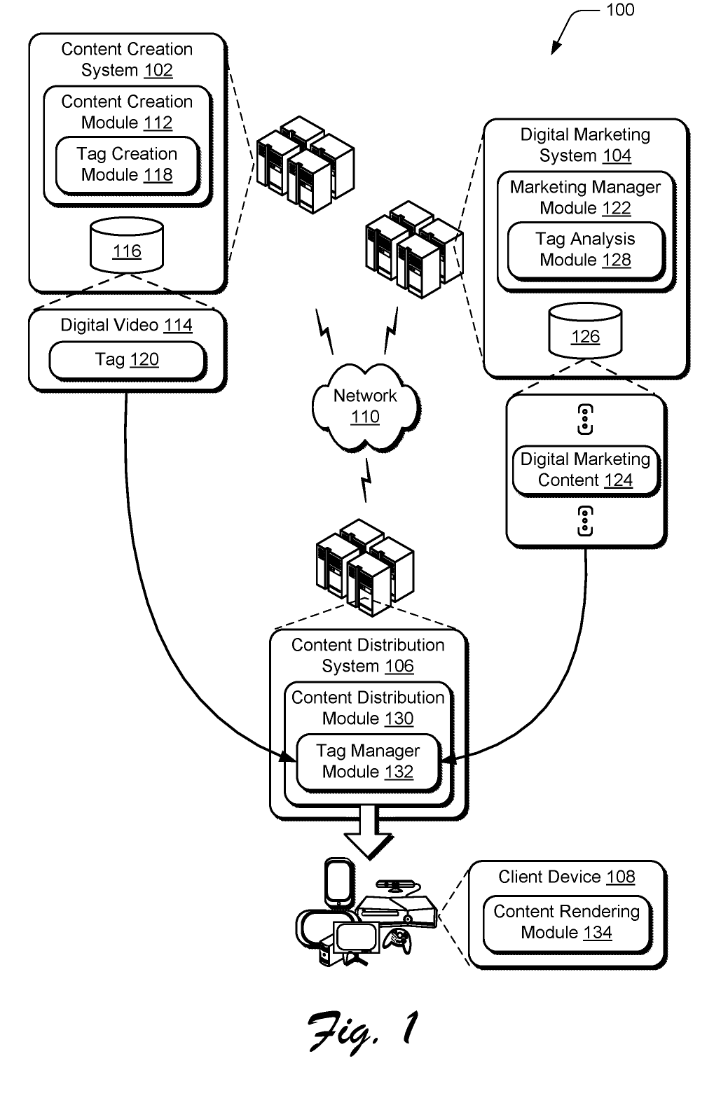

FIG. 1 is an illustration of a digital medium environment 100 in an example implementation that is operable to employ techniques described herein. The illustrated environment 100 includes a content creation system 102, a digital marketing system 104, a content distribution system 106, and one or more client devices 108 that are communicatively coupled, one to another, via a network 110. Computing devices that implement these systems and client devices may be configured in a variety of ways.

A computing device, for instance, may be configured as a desktop computer, a laptop computer, a mobile device (e.g., assuming a handheld configuration such as a tablet or mobile phone as illustrated for the client device 108), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is described in instance of the following, a computing device may be representative of a plurality of different devices, such as multiple servers utilized by a business to perform operations “over the cloud” as shown for the content creation system 102, digital marketing system 104, and content distribution system 106.

The content creation system 102 is illustrated as including a content creation module 112. The content creation module 112 is implemented at least partially in hardware of the content creation system 102 (e.g., processing system and computer readable storage media) to process and transform digital video 114, which is illustrated as maintained in a storage device 116. Such processing includes creation of the digital video 114, modification of the digital video 114, and rendering of the digital video 114 in a user interface for output, e.g., by a display and audio output device.

An example of functionality incorporated by the content creation module 112 is illustrated as a tag creation module 118. The tag creation module 118 is configured to associate a tag 120 at respective portions of the digital video 114 to describe characteristics of content included within frames included in that portion of the video, e.g., a subset of frames. The tag 120, for instance, may be configured to describe an emotional state associated with content included within that portion, e.g., happy, somber, suspenseful, frightened, cheerful, enthusiastic, and so forth. In another instance, the tag 120 is configured to describe geographic locations, actors, genre, weather conditions, product placement, actions performed, and other content. In a further instance, the tag 120 represents content creation characteristics of content included within the respective portion, e.g., colors used, lighting conditions, digital filters, etc. Thus, the tag 120 describes characteristics of what is included within frames within respective portions of the content, and not just a reference to the frames themselves, e.g., timestamps. A variety of other instances are also contemplated, such as director, year made, and so forth.

The tags 120 support techniques by which a creative professional, through interaction with the content creation system 102, is given a degree of control of subsequent use of the digital video 114. This degree of control is made possible by specifying characteristics of content included within respective frames of the digital video 114 through use of the tag 120. The tag 120, for instance, may be used as insight during subsequent rendering regarding “what content” is included in that portion of the video, which is not possible in conventional techniques that relied on a “best guess.”

Conventional digital marketing systems, for instance, may make judgements based on an overall genre of a digital video 114, and not individual portions of the video nor even a particular episode of a video series. Therefore, inclusion of the tag 120 as part of the digital video 114 may be used by a creative professional to increase consistency of output of digital marketing content with corresponding portions of the digital video 114. This promotes a consistent look and feel in the output of digital marketing content 124 as part of the digital video 114 and thus an improved overall user experience.

The tag 120 may also be used to support a variety of functionality to the digital marketing system 104, such as to control output of digital marketing content 124 in conjunction with the digital video 114. The digital marketing system 104, for instance, includes a marketing manager module 122 that is configured to output digital marketing content 124 as part of the digital video 114 by the content distribution system 106. The digital marketing content 124 is illustrated as stored in a storage device 126 and may take a variety forms for output in conjunction with the digital video 114.

The digital marketing content 124, in a first instance, is also configured as video that is output during a “break” in the output of the digital video 114, e.g., at a commercial break. Therefore, in this instance the digital marketing content 124 replaces output of the digital video 114 for an amount of time. In another instance, the digital marketing content 124 is configured for output concurrently with the digital video 114, e.g., as a banner advertisement that is displayed proximal to the digital video 114 in a user interface when rendered. Other instances are also contemplated, such as virtual product placement. Thus, digital video 114 supports output of digital marketing content 124 at different times and thus introduces challenges over other types of digital content.

The digital marketing system 104 also includes a tag analysis module 128 that is configured to control which items of digital marketing content 124 are provided to the content distribution system 106 for output with the digital video 114 based on the tags 120. The digital marketing system 104, for instance, may receive data indicating that the tag 120 describes a respective portion of the digital video 114 to be streamed to the client device 108 through execution of a content distribution module 130. Based on the tag 120, the tag analysis module may determine which item of digital marketing content 124 to select from the storage device 126 based on characteristics associated with the tag 120 and thus the corresponding portion of the digital video 114. This may be performed using tag matching (e.g., to match tags of the digital marketing content 124 to the tag 120 of the digital video 114), rules based as implemented by a rules engine (e.g., to select digital marketing content 124 for an emotional state of “happy” in response to detect of a tag 120 of the digital video indicative of an emotional state of “sad), based on machine learning, and so forth.

This item is then communicated (e.g., streamed) over the network 110 to the content distribution system 106. A tag manager module 132 of the content distribution system 106 then configures the digital marketing content 124 for output in conjunction with the digital video 114, e.g., when rendered by a content rendering module 134 of the client device 108. The digital marketing content 124, for instance, may be configured as a video, banner advertisement, and so forth that replaces an output of the digital video 114 or is output concurrently with the digital video 114 as described above. Thus, digital marketing content 124 may be output with respect to digital video 114 in a variety of ways that are not possible for other types of digital content.

In at least one implementation, machine learning techniques are employed that are configured to address the complexities of digital video 114. In a first example, machine learning (e.g., a neural network) is employed to automatically generate tags for association with respective portions of the digital video 114. A machine learning system, for instance, may be employed by the content creation system 102, digital marketing system 104, and/or content distribution system 106 to generate tags based on models trained using training digital video and corresponding tags 120. As a result, the portions of the digital video 114 may be tagged automatically and without user intervention through classification by the model in an efficient and accurate matter without requiring users to manually enter tags, which may be subjective and inaccurate.

This may be used to address “live” digital video 114 that is output in real time. Machine learning, for instance, may be used to generate the tag 120 for the digital video 114 as it is streamed to the client device 108. The digital video 114, for instance, may relate to a sporting event and the tag 120 may describe characteristics of the sporting event, such as a time within an output of the video (e.g., halftime), status (e.g., 0-0 ties), and so forth. Conflicting tags may also be generated, such as to tag a positive output for one team and a negative outcome for another team based on geographic location. Based on this, digital marketing content 124 is selected accordingly as described above, e.g., via tag matching, rules based, machine learning, and so forth.

In another example, training data is obtained that describes user interaction (e.g., conversion) with digital marketing content 124 and tagged 120 digital videos 114. This training data is then used to train a model to generate suggestions regarding which items of digital marketing content 124 to be output with respect to different tags 120. In this way, the model may uncover associations based on the tag 120 and usage data that are not readily apparent to a human, such as to cause output of a cheerful item of digital marketing content 124 proximal to an emotionally sad portion of digital video 114.

This may also incorporate knowledge of user segments that are part of this interaction (e.g., demographics of respective users) to further increase a likelihood of conversion. Users of respective client devices 108, for instance, may login to the content distribution system 106 in order to receive the digital marketing content 124, e.g., via a browser, web app, and so forth. As part of this, the content distribution system 106 collects demographic information from users of the client devices 108, e.g., age, geographic location, and so forth. This information may then be used to assign the users to respective segments of a user population, e.g., through matric factorization to identify these segments. Actions of these user population segments may then be incorporated as part of the training data and thus leverage knowledge of the user, the tags, any actions taken (e.g., conversion), and the digital marketing content 124 provided to train a model to have increased accuracy in selection of digital marketing content 124.

Additionally, techniques and systems are also described that support flexibility in output of the digital marketing content 124 regarding time with respect to the digital video 114. As previously described, digital video 114 supports output of digital marketing content 124 at different times and thus introduces complexities not found in other types of digital content. The digital marketing content 124, for instance, may be displayed as a banner ad at any time concurrently in relation to the output of the digital video 114, may be displayed at one or more commercial breaks that are preconfigured and manually or automatically selected, and so forth. Accordingly, techniques and systems are also described to leverage machine learning to determine an optimal time, at which, to output digital marketing content 124 in relation to an output of the digital video 114.

Training data, for instance, may be received that describes a time at which digital marketing content 124 is output with respect to a portion of digital video 114, and may even describe a tag 120 associated with that portion, segment of user population, and so on. A model may then be trained using machine learning to control when the digital marketing content 124 is output based on these considerations, e.g., as a banner ad, as a video during a “commercial break” formed based on the model, and so forth. Such control is not possible in conventional techniques and systems as applied to non-video forms of digital content, e.g., webpages. In this way, machine learning may be used to address the complexities and dynamism of digital video 114. Further discussion of these and other examples is included in the following description.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

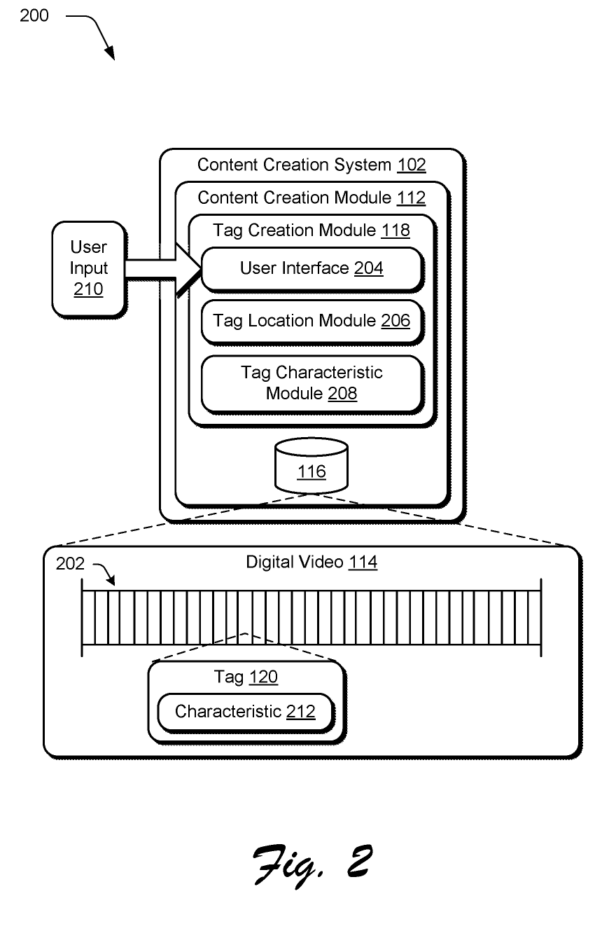

FIG. 2 depicts an example implementation 200 showing operation of the tag creation module 118 of the content creation system 102 of FIG. 1 in greater detail. In this example, the digital video 114 is illustrated as including a plurality of frames 202 that are output in succession, e.g., based on respective timestamps. The tag creation module 118 is configured in this instance to output a user interface 204 and includes a tag location module 206 and a tag characteristic module 208.

The user interface 204 is configured to receive a user input 210 to create, modify, or otherwise edit the digital video 114, e.g., from a creative professional. As part of this, the user input 210 may specify a tag 120 and characteristic 212 of the tag 120 at a respective portion of the digital video 114. The tag 120, for instance, may be associated with a timestamp of a particular frame 202 of the digital video 114, associated with a segment obtained upon examination of a manifest in a streaming example, as part of metadata, and so forth. Accordingly, the tag location module 206 is configured to associate the tag 120 at the corresponding location and the tag characteristic module 208 is configured to select the tag from a plurality of tags that are associated with a desired characteristic.

A creative professional, for instance, may initiate the user input 210 to select from a plurality of tags, each associated with a respective semantic state or other characteristic 212 as desired. Examples of semantic states include emotional states such as happy, sad, depressed, excited, and so forth elicited by content included in the portion of digital video 114. Other characteristics 212 described by semantic states include actors, genre, lighting conditions, or any other characteristic describing the content included within the frames 202 of the digital video 114. Thus, inclusion of tags in the digital video 114 provides an ability to describe characteristics of “what” is included in content at respective portions of the digital video 114. This description, through use of the tags, may further be leveraged to control output of related content (e.g., digital marketing content 124) as well as gain insight into how the digital video 114 is consumed as further described in the following example.

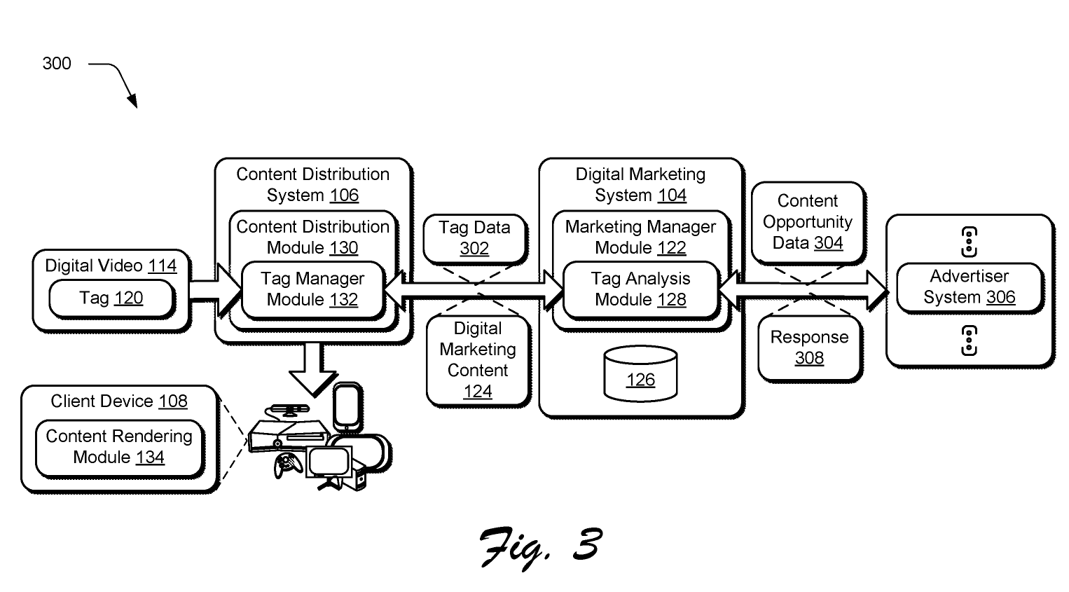

FIG. 3 depicts an example system 300 in which the tag 120 is used as a basis to control output of digital marketing content 124 in conjunction with digital video 114. In this example, digital video 114 having a tag 120 is received by a content distribution system 106 for streaming to and rendering by a client device 108. Upon receipt of the digital video 114, the tag manager module 132 identifies a tag 120 associated with the video. Tag data 302 describing this tag 120 is then communicated via the network 110 to the digital marketing system 104 and used to select digital marketing content 124 for output in conjunction with the digital video 114. This selection may be performed in a variety of ways.

In one example, content opportunity data 304 is provided by the digital marketing system 104 to advertiser systems 306 via the network 110. The content opportunity data 304, for instance, may include the tag data 302, data indicating the digital video 114, and other characteristics involving the output of the digital video 114, e.g., segment data describing users associated with the client devices 108. The advertiser systems 306 may then bid or otherwise avail themselves of the opportunity, if desired as indicated in the response 308, to advertise using digital marketing content 124. Thus, in this example the digital marketing system 104 make these opportunities available “outside” of the digital marketing system 104.

The digital marketing system 104 may also be configured to select the digital marketing content 124 itself. The digital marketing system 104, for instance, may receive digital marketing content 124 from the advertiser systems 306 and store it in the storage device 126. The tag analysis module 128 is then configured to select from the digital marketing content 124 for inclusion as part of output with the digital video 114 in response to guidelines specified by the advertiser system 306. This selection may be performed in a variety of ways, an example of which is described as follows.

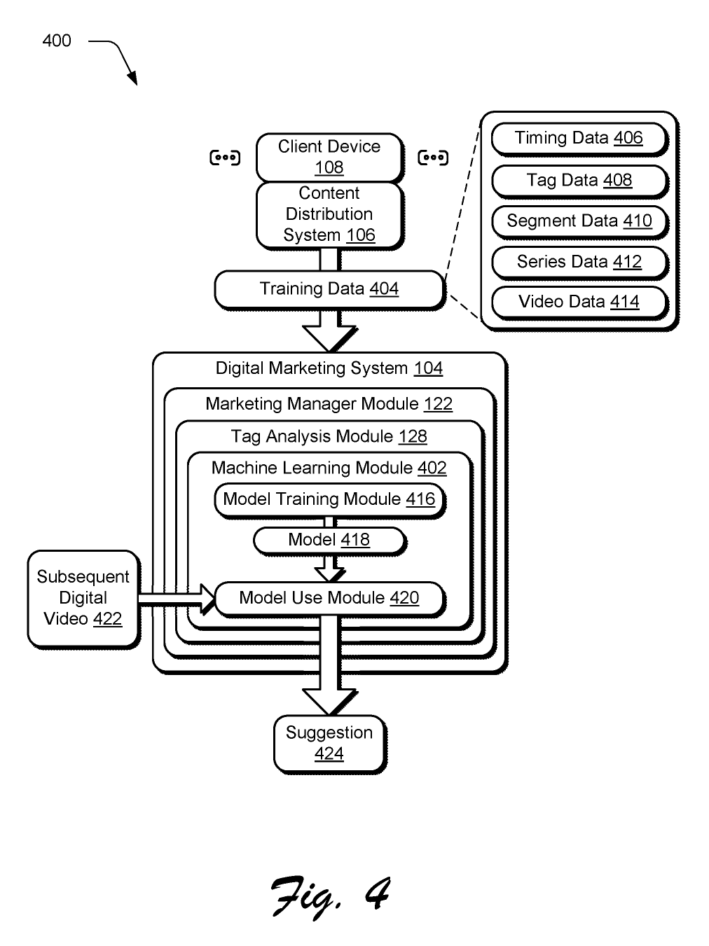

FIG. 4 depicts an example implementation 400 showing operation of the digital marketing system 104 in greater detail as employing machine learning to generate a suggestion. In this example, the tag analysis module 128 includes a machine learning module 402 that is configured to employ machine learning (e.g., a neural network) using training data 404 to generate a model 418. The training data 404 may be obtained from a variety of sources, such as from the client device 108 directly or indirectly via the content distribution system 106. The client device 108, for instance, may execute a mobile application associated with the content distribution system 106 (e.g., a dedicated streaming application and service) that collects this training data 404 from a user upon logging in to the system. In another example, the training data 404 is obtained from a generally-accessible streaming service, e.g., via application, browser, and so on without logging in. A variety of other examples are also contemplated.

The training data 404 is configured to describe user interaction with the digital video 114 and digital marketing content 124. To do so, the training data 404 may describe a variety of characteristics involving consumption of training digital videos. Illustrated examples of characteristics described by the training data 404 involving this user interaction including timing data 406 (e.g., when the digital marketing content 124 is output in relation to the video data 114), tag data 408 (e.g., describing tags 120 associated with respective output of digital marketing content 124), segment data 410 (e.g., user demographics), series data 412 (e.g., whether the training digital video is included in an arranged video series), video data 414 describing the digital video 114 itself, and so on.

All or a variety of combinations of this training data 404 is then provided to the digital marketing system 104 in this example. A tag analysis module 128 then employs a machine learning module 402 having a model training module 416 to train a model 418 using machine learning. A variety of times of machine learning techniques may be employed, such as linear regression, logistic regression, decision tress, structured vector machines, naïve Bayes, K-means, K-nearest neighbor, random forest, neural networks, and so forth. The tag analysis module 128 also includes a model use module 420 to employ the model 418 to process a subsequent digital video 422 to generate a suggestion 424. The suggestion 424 may be configured in a variety of ways based on the training data 404 used to train the model 418 to support a wide range of functionality.

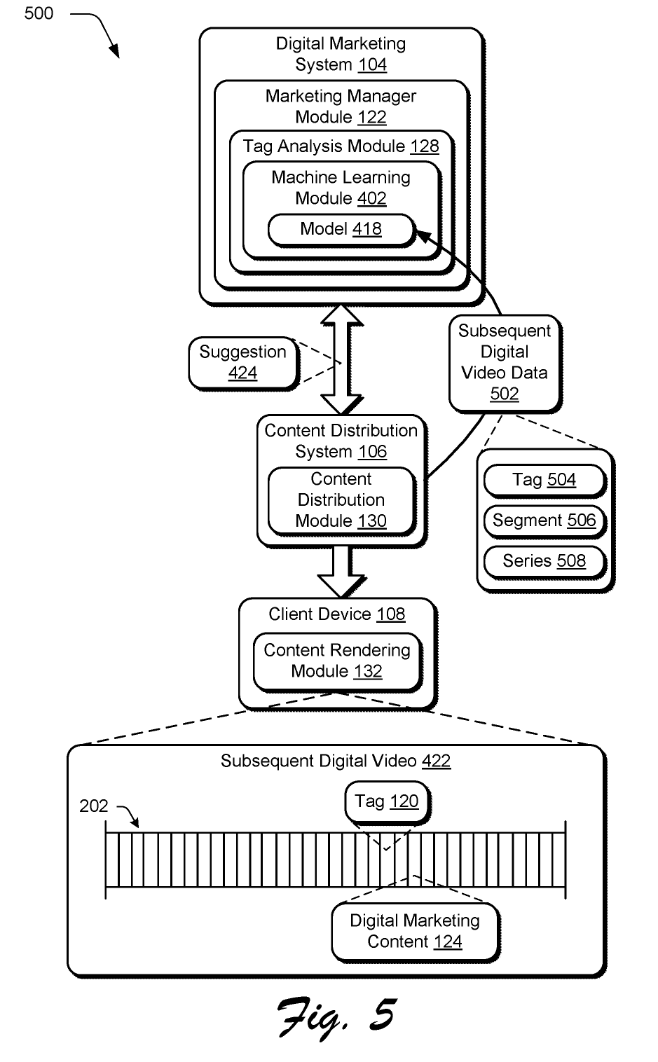

FIG. 5 depicts a system 500 in an example implementation in which a suggestion is generated based on machine learning usable to control output of digital marketing content 124 with respect to digital video 114. In this example, the machine learning module 402 employs a model 418 trained as described in relation to FIG. 4. As described there, this model 418 may be trained using a variety of different types of training data 404 and as such may be used to support generation of a variety of different types of suggestions 424. In this example, the suggestion 424 is configured to control output of digital marketing content 124 with respect to a subsequent digital video 422.

The machine learning module 402, for instance, may obtain subsequent digital video data 502 that describes characteristics of the subsequent digital video 422 to be output to and rendered by a client device 108. The data may be configured as text that describes the digital video (e.g., a review), a portion of the digital video (e.g., a trailer), and even the digital video itself. This data is then processed by the model 418 to suggest a time indicating when the digital marketing content 124 is to be output with respect to the subsequent digital video 422, e.g., through use of a timestamp to indicate a particular frame 202. Further, this may be performed for specific types of digital marketing content 124, e.g., to distinguish between a banner ad and a video advertisement. The suggestion 424 is then output to indicate this time to control output of the digital marketing content 124 with respect to a particular frame 202 or frames of the subsequent digital video 422. In this way, output of the digital marketing content 124 may be optimized with respect to the subsequent digital video 422 and addresses the challenge of digital video.

Other considerations may also be taken into account. The subsequent digital video data 502, for instance, may reference a tag 504 that indicates a characteristic of a portion of the subsequent digital video 422, e.g., an emotional state. The subsequent digital video data 502 is then processed by the model 418 using machine learning to generate a suggestion 424 to select digital marketing content 124 for output. As previously described, the suggestion 424 may vary as greatly as the characteristics that may be described using the tag 504, e.g., emotional states, characteristics of the content included at the portion, characteristics in how that content is captured or created, and so forth. In this way, characteristics of digital video and relationships to digital marketing content 124 may be uncovered that are not readily determinable by a human user, such as associations between disparate emotional states.

The subsequent digital video data 502 may also describe a segment 506 of a user population, to which, a prospective viewer of the subsequent digital video 422 belongs. This may be processed by the machine learning module 402 while also taking into account the tag 504 and video itself to generate a suggestion 424 as to which item of digital marketing content 124 is to be output. This may also be combined with the timing considerations to also specify when (e.g., via a timestamp) the digital marketing content 124 is to be output as described above. In this way, the digital marketing system 104 may address the complexities of the subsequent digital video 422 to select and control output of digital marketing content 124.

Other considerations may also be described as part of the subsequent digital video data 502, such as to describe whether the subsequent digital video 422 is part of a video series 508, an order in that series, and so on. A model, for instance, may be trained based on a particular video series, which may thus have increased accuracy in generation of suggestions regarding subsequent digital videos. As a result, this information may help improve accuracy and computational efficiency in generation of the suggestion 424. In this example, the suggestion 424 is used to control output of the digital marketing content 124. The suggestion 424 may also be configured as a guide to content creation for use as part of a content creation system 102, an example of which is described as follows.

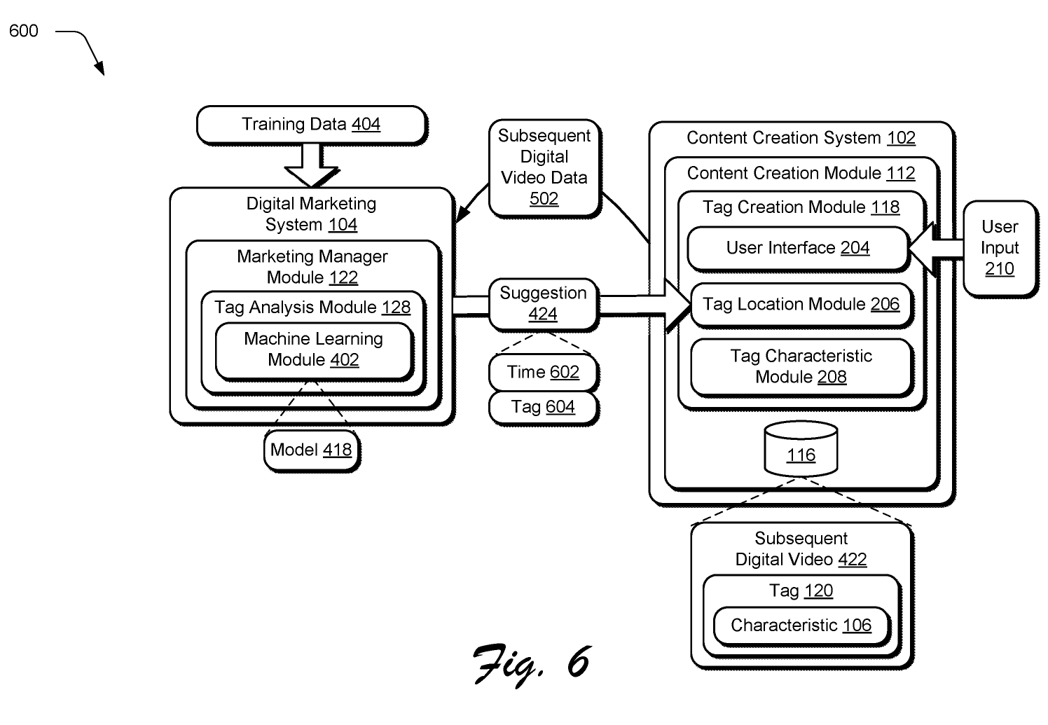

FIG. 6 depicts a system 600 in an example implementation in which a suggestion is generated to guide content creation through user interaction with a content creation system 102. In this example, the digital marketing system 104 trains a model 418 as previously described. In this example, the digital marketing system 104 generates suggestions 424 that are communicated to the content creation system 102 to guide creation of the digital video 114. The suggestion 424, for instance, may include an indication of a time 602, at which, to configure the digital video 114 to output digital marketing content 124. This suggestion 424, for instance, may be output in a user interface 204 to indicate times, at which, output of digital marketing content 124 has been successful. As a result, creation of the subsequent digital video 422 may be guided so as to be configured to output the digital marketing content 124 at this time, e.g., through commercial breaks, configured placement of banner ads, and so on.

The suggestion 424 may also indicate tags 604 that have been successful as part of output of digital marketing content 124, e.g., to cause conversion. Thus, these tags 604 may also be indicated in a user interface 204 to guide content creation to have these characteristics. Additional information may also be included, such as segments of a user population that correspond to the tags and/or times. As a result, creation of the subsequent digital video 422 may also be guided by these tags 604 and segments.

The content creation system 102 may also employ machine learning to process the subsequent digital video 422. This may include automated placement of tags 120 at respective locations within the subsequent digital video 422. This may also continue the previous examples to generate suggestions 424 based on training data 404 as well as the subsequent digital video 422. For example, this may be used to suggest additional tags and corresponding characteristics based on existing tags 120 and portion of video already created as part of the subsequent digital video 422. In this way, the content creation system 102 expands insight into use of digital video and respective digital marketing content that is not possible in conventional systems. In the example above, machine learning is employed by the digital marketing system 104. This functionality may also be employed singly or in combination with the content creation system 102, content distribution system 106, and even client devices 108 to leverage tags and timing techniques described above.

### Example Procedures

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIGS. 1-6.

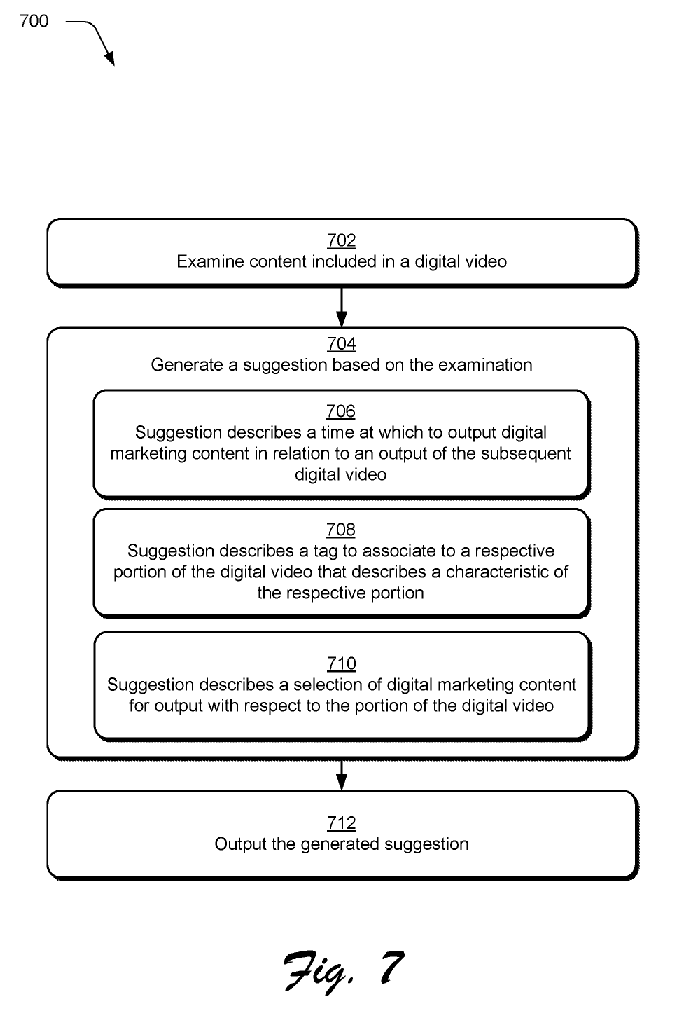

FIG. 7 depicts a procedure 700 in an example implementation of control of digital marketing content with respect of a digital video. To begin, content included in a digital video is examined (block 702). This examination may be performed in a variety of ways, such as to detect tags included in the video. In a machine learning example, a model is trained using machine learning based on training data to generate tags in real time, e.g., for “live” streaming digital video 114 based on identification of content (e.g., objects) included in frames of the video.

The training data, for instance, may describe training digital videos, tags included in the training digital videos, segments of a user population that viewed the training digital videos, digital marketing content output in conjunction with the training digital videos, times at which the digital marketing content is output in conjunction with the training digital videos, user interactions (e.g., conversion) resulting from this output, and so forth. Thus, the model may be trained to address a variety of considerations in the output of digital marketing content with respect to the training digital videos.

A suggestion is generated by processing data describing a subsequent digital video based on the examination (block 704), e.g., through machine learning, a rules based engine, tag matching, and so forth. The suggestion, for instance, may describe a time at which to output digital marketing content in relation to an output of the subsequent digital video (block 706). In another instance, the suggestion describes a tag to associate to a respective portion of the digital video that describes a characteristic of the respective portion (block 708), e.g., in “real time” for live streaming video.

The suggestion may also describe a selection of digital marketing content for output with respect to the portion of the digital video (block 710), e.g., through machine learning, tag matching, or use of rules through a rules engine based on emotional states. Tag matching, for instance, may be used to match tags included in the digital video 114 to takes in the digital marketing content 124, may use rules (e.g., for correlation of different emotional states), and so forth. Other examples include configuration of the suggestion to guide creation of digital video 114 as described in relation to FIG. 6. The generated suggestion is then output (block 712), e.g., in a user interface to guide digital video creation, to control output of digital marketing content, and so forth.

### Example System and Device

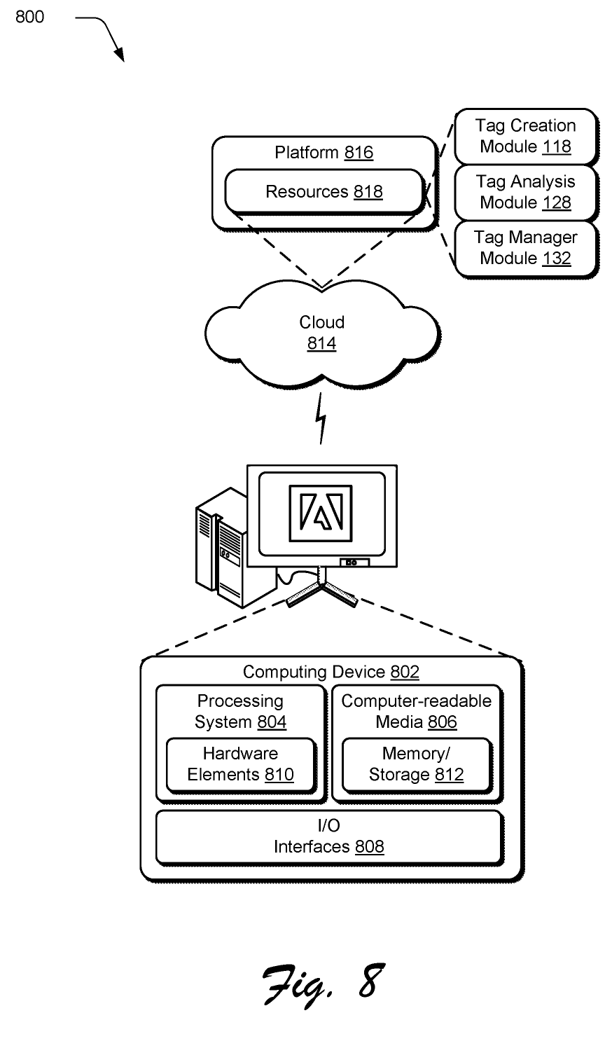

FIG. 8 illustrates an example system generally at 800 that includes an example computing device 802 that is representative of one or more computing systems and/or devices that may implement the various techniques described herein. This is illustrated through inclusion of the tag creation module 118, tag analysis module 128, and tag manager module 132. The computing device 802 may be, for example, a server of a service provider, a device associated with a client (e.g., a client device), an on-chip system, and/or any other suitable computing device or computing system.

The example computing device 802 as illustrated includes a processing system 804, one or more computer-readable media 806, and one or more I/O interface 808 that are communicatively coupled, one to another. Although not shown, the computing device 802 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including hardware element 810 that may be configured as processors, functional blocks, and so forth. This may include implementation in hardware as an application specific integrated circuit or other logic device formed using one or more semiconductors. The hardware elements 810 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 806 is illustrated as including memory/storage 812. The memory/storage 812 represents memory/storage capacity associated with one or more computer-readable media. The memory/storage component 812 may include volatile media (such as random access memory (RAM)) and/or nonvolatile media (such as read only memory (ROM), Flash memory, optical disks, magnetic disks, and so forth). The memory/storage component 812 may include fixed media (e.g., RAM, ROM, a fixed hard drive, and so on) as well as removable media (e.g., Flash memory, a removable hard drive, an optical disc, and so forth). The computer-readable media 806 may be configured in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 802. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 802, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 810. The computing device 802 may be configured to implement particular instructions and/or functions corresponding to the software and/or hardware modules. Accordingly, implementation of a module that is executable by the computing device 802 as software may be achieved at least partially in hardware, e.g., through use of computer-readable storage media and/or hardware elements 810 of the processing system 804. The instructions and/or functions may be executable/operable by one or more articles of manufacture (for example, one or more computing devices 802 and/or processing systems 804) to implement techniques, modules, and examples described herein.

The techniques described herein may be supported by various configurations of the computing device 802 and are not limited to the specific examples of the techniques described herein. This functionality may also be implemented all or in part through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 may include applications and/or data that can be utilized while computer processing is executed on servers that are remote from the computing device 802. Resources 818 can also include services provided over the Internet and/or through a subscriber network, such as a cellular or Wi-Fi network.

The platform 816 may abstract resources and functions to connect the computing device 802 with other computing devices. The platform 816 may also serve to abstract scaling of resources to provide a corresponding level of scale to encountered demand for the resources 818 that are implemented via the platform 816. Accordingly, in an interconnected device embodiment, implementation of functionality described herein may be distributed throughout the system 800. For example, the functionality may be implemented in part on the computing device 802 as well as via the platform 816 that abstracts the functionality of the cloud 814.

### CONCLUSION

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium environment to customize a time at which digital marketing content is output in relation to a digital video, a method implemented by at least one computing device, the method comprising:
examining, by the at least one computing device, content included in a digital video:
generating, by the at least one computing device, a suggestion based on the examining, the suggestion specifying a time at which an item of digital marketing content is to be output in relation to output of the digital video; and
outputting, by the at least one computing device, the generated suggestion to control output of the item of digital marketing content in relation to the subsequent digital video.

2. The method as described in claim 1, wherein the generated suggestion describes the time in the output of the subsequent digital video through use of a timestamp or the time as associated with a particular frame of a plurality of frames of the digital video.

3. The method as described in claim 1, wherein the generated suggestion describes the time as a break that is to occur in the output of the subsequent digital video to output the item of digital marketing content.

4. The method as described in claim 1, wherein the generating is performed based at least in part on tag matching or a rules engine.

5. The method as described in claim 1, wherein the examining is performed using a model trained using machine learning based on training data that describes:
user interaction with training digital marketing content output in conjunction with at least one training digital video; and
a time at which the training digital marketing content is output in relation to the at least one training digital video.

6. The method as described in claim 5, wherein:
the training data describes segments of a user population that correspond to the user interaction;
the training of the model is based at least in part on the segments described in the training data; and
the generating of the suggestion by the model is also based at least in part on identification of at least one of the segments of the user population that is to interaction with the item of the digital marketing content.

7. The method as described in claim 5, wherein:
the training data includes tags that describe characteristics of the digital video output in conjunction with the digital marketing content;
the training of the model is based at least in part on the tags described in the training data; and
the generating of the suggestion by the model is also based at least in part on identification of at least one of the tags of the subsequent digital video.

8. The method as described in claim 5, wherein the training data describes a series of said digital videos output in succession and the generating is based at least in part on identification of the subsequent digital video as part of a series of digital videos.

9. The method as described in claim 5, wherein the training digital marketing content is a banner advertisement or a video advertisement that is selectable to cause conversion of a good or service and the training data describes whether or not conversion is caused by the training digital marketing content.

10. The method as described in claim 1, wherein the generated suggestion is configured for output in a user interface of a content creation system that creates the subsequent digital video.

11. The method as described in claim 1, wherein the generated suggestion is configured to control the time at which the item of digital marketing content is output in relation to the subsequent digital video in a stream from a content distribution system to a client device via a network.

12. In a digital medium environment to control output of digital marketing content with respect to a digital video, a method implemented by at least one computing device, the method comprising:
training, by the at least one computing device, a model using machine learning based on training data, the training data describing:
user interaction with training digital marketing content output in conjunction with respective portions of at least one training digital video; and
a tag that describes a characteristic of the respective portions of the at least one training digital video;
generating, by the at least one computing device, a suggestion by processing a subsequent digital video based on the model using machine learning, the suggestion specifying whether to apply the tag to a respective portion of the subsequent digital video; and
outputting, by the at least one computing device, the generated suggestion.

13. The method as described in claim 12, wherein the tag describes an emotional state associated with the respective portions of the at least one training video.

14. The method as described in claim 12, wherein the tag is associated with a particular frame of the at least one training video.

15. The method as described in claim 14, wherein the generated suggestion identifies a particular frame of the subsequent digital video, with which, the tag is to be associated with.

16. In a digital medium environment to customize output of digital marketing content in conjunction with a digital video, a computing device comprising:
a processing system; and
a computer-readable storage medium having instructions stored thereon that, responsive to execution by the processing system, causes the processing system to perform operations comprising:
detecting a tag included in the digital video that describes content included within a respective portion of the digital video;
selecting an item of digital marketing content that is to be output in relation to output of the digital video based on the detected tag; and
controlling output of the selected item of digital marketing content in relation to the digital video.

17. The computing device as described in claim 16, wherein the tag describes an emotional state exhibited by the respective portion of the digital video.

18. The computing device as described in claim 16, wherein the selecting is performed using machine learning.

19. The computing device as described in claim 16, wherein the selecting is based on the tag associated with the digital video and a tag associated with the item of digital marketing content.

20. The computing device as described in claim 16, wherein the operations further comprise assign the tag to the digital video in real time as the digital video is streamed.
